(19) United States
(12) Patent Application Publication
(10) Pub. No.: US 2006/0187383 A1
(43) Pub. Date: Aug. 24, 2006

(54) Method of manufacturing a reflector and liquid crystal display device including such a reflector

(76) Inventors: Dirk Jan Broer, Eindhoven (NL); Christiane Maria Rosette De Witz, Eindhoven (NL); Ties Van Bommel, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/564,327

(22) PCT Filed: Jul. 15, 2004
(86) PCT No.: PCT/IB04/51231

§ 371 Date: Jan. 10, 2006

(30) Foreign Application Priority Data
Jul. 17, 2003 (EP) 03102200.7

(51) Int. Cl. G02F 1/1335

(52) U.S. Cl. 349/113; 349/114

(57) ABSTRACT

The invention relates to a method for manufacturing a diffusive reflector (450) for a reflective or transflective Liquid Crystal Display (400). The reflector comprises a surface (452) that is structured by means of a photo-embossing process. Herein, a layer (100) of a mixture is provided including a photo-diffusible monomer (102), which may be transported through the layer under the influence of selectively applied irradiation. A layer relief is thus formed, which is preferably developed further at an elevated temperature. The layer is fixed and stabilized by means of a cross-linking step, preferably including thermally induced and/or photo-induced polymerization. In a final step, the polymer relieved surface thus formed is provided with a reflective material (154).

The invention relates to a method of manufacturing a reflective optical element for use in a liquid crystal display device.

Liquid Crystal Displays (LCDs) are increasingly used in computer monitors, television sets, handheld devices et cetera. For mobile applications, LCDs have become the standard display device due to low power consumption, reliability and low price.

The operation of LCDs is based on light modulation in an active layer of a liquid crystalline (LC) material. By changing an electric field, the light modulation of the active layer is altered, and characteristics of the light passing through the LC layer are modified. Generally the active layer modifies a state of polarization of the passing light.

The active layer is sandwiched between a front substrate on a viewing side of the LCD, and a rear substrate. The part of the LCD in between the front substrate and the rear substrate is generally referred to as the cell. Thus the cell comprises the active layer of the liquid crystalline material, optionally one or more in-cell optical components, and in a color LCD also color filters.

An LCD for example relies on the Twisted Nematic (TN) effect Polarizers are provided on the outer surfaces of the front and the rear substrate, which polarizers have their polarization axes oriented perpendicularly with respect to each other. Linearly polarized light enters the cell, and a birefringence of the twisted nematic liquid crystalline material may change the state of polarization of the linearly polarized light, in dependence of the electric field being applied. In particular, the polarization vector of the light may rotate.

The amount of light passing through the front polarizer is dependent on the change in polarization effected by the active layer. The intensity of the light exiting from the cell can be varied by applying a voltage difference over the cell, thereby changing the applied electric field.

LCDs are generally operable in one or both of two modes, namely a transmissive mode and a reflective mode. In a transmissive LCD, light originating from a backlight adjacent to the rear substrates is modulated. Transmissive LCDs generally have a good contrast ratio, however when used in an outside environment the display becomes practically unreadable.

The active layer in a reflective LCD modulates ambient light that impinges on the display. The reflective LCD relies on a reflector which is preferably located in the cell. It reflects modulated ambient light back towards the viewer. Thus, in the reflective mode, ambient light generally passes through the active layer twice. The reflector is usually provided in the form of a mirror adjacent or on the rear substrate.

Mobile devices may incorporate a so-called transflective LCD, which operates in the transmissive and reflective modes at the same time. This has the advantage that the display is usable both under bright and dark external light conditions. In the latter case, light from the backlight is used for viewing the display.

For this purpose, in a transflective LCD, a reflector is used comprising a partial mirror. That is, the reflective layer is provided with openings for the transmissive parts of the cell, through which openings light from the backlight is able to pass. In a transflective LCD, the reflector may comprise a structured layer that establishes a different cell thickness for the transmissive and reflective parts of the cell. The reflective material is provided on top of this structured layer, generally on those portions thereof that correspond to the reflective parts of the cell.

Preferably, the reflector in a reflective or transflective LCD also diffuses light incident onto it. Light which falls on the reflector at a given angle of incidence is redistributed into a viewing cone comprising a range of reflection angles. When a viewer is within the viewing cone, light is reflected towards him so that he is able to read the display. When the viewing cone is relatively wide, the viewer is able to observe the display through a large range of viewing angles. When the viewing cone is narrow the image is bright but can be observed within a limited viewing range. The most optimized viewing cone is therefore a trade-off between viewing angle and display brightness and the optised value depends on the application.

A diffusive reflector has the advantage that the viewing characteristics of the reflective LCD are improved.

Conventionally, a diffusive reflector is made entirely in a vacuum process. The mirror is applied on a substrate coated with a polymer film that is provided with a surface relief. This relief is formed by irradiating the polymer film through a patterned mask, and subsequently etching the irradiated portions of the polymer film using a lithographic process carried out under vacuum. The surface relief must be well controlled but irregularly shaped for optimizing the redistribution of the reflected light. In a final step, reflective material is provided onto the structured surface, for example by means of metal vapor deposition.

The known process has the disadvantage that it is relatively complex and expensive, as it involves the use of lithographic processes and must be carried out entirely under vacuum conditions.

It is therefore an object of the invention to provide a manufacturing method for a reflector in a reflective or a transfiective LCD, which is relatively simple and inexpensive.

This object has been achieved by means of the manufacturing method according to the invention as specified in the independent claim 1. Further advantageous embodiments are defined in the dependent claims 2-17.

It is a further object of the invention to provide a liquid crystal display with an improved diffusive reflector which can be manufactured with relative ease.

This object has been achieved by means of the liquid crystal display according to the invention as specified in the independent claim 18. Further advantageous embodiments are defined in the dependent claims 19, 20 and 21.

According to the invention, the surface of the reflector is structured by means of a photo-embossing process. This process relies on photo-induced diffusion of the photo-diffusible monomer in the mixture. The photo-diffusible monomer is able to diffuse through the layer by applying suitable irradiation such as ultraviolet (UV) light.

By using patterned irradiation, this photo-induced diffusion effect can be used to structure the layer. The patterned irradiation defines bright areas and dark areas in the layer. The photo-diffusible monomer diffuses towards an irradiated area. As a result, effectively material transport takes place, directed from the dark areas towards the bright areas. The thickness of the layer increases in the bright areas and decreases in the dark areas. This process is also referred to as photo-embossing in this document.

For the exposed (bright) areas, photo-diffusible monomer diffuses into this area, where the local volume increases. Preferably, the photo-diffusional monomer is a monomer that contains at least one polymerizable group forming a cross-linked polymer network after polymerization. In this case, at least part of the monomer in the exposed areas polymerizes and crosslinks. The transported material is thereby fixed, so that counter-diffusion is prevented.

The unexposed (dark) areas, that consequently have a decreased layer volume, may subsequently be crosslinked as well by means of a photo-initiated or preferably a thermal polymerization reaction of the remaining monomer. In this cross-linking step, the whole layer is permanently fixed and stabilized. For this purpose, it is preferred when the mixture includes a thermal initiator.

Thus, a polymer layer having the desired surface structure is easily obtained without the need for additional solvent flush or other development methods. The surface relief can be formed without the use of lithography and/or vacuum, so that manufacturing complexity is decreased and costs are lower.

According to the invention, a mixture of two or more monomers could be chosen that have different diffusion properties. It is preferred that one of the materials in the mixture has a low diffusion coefficient with respect to the photo-diffusible monomer.

Most preferably, the mixture further includes a polymer in addition to the photo-diffusible monomer. The advantage to incorporate a polymer into the material system is that, before exposure, basically a solid, non-sticking film is formed which in contact with a mask does not deform, or contaminate the mask. Thus, the mixture is easier to process. Moreover, a dry film is also less sensitive towards dust uptake than a film that is still wet.

In this case, the surface relief may be particularly high because the polymer in the mixture is essentially immobile. Thereby, counter-diffusion effects are minimized.

In a final manufacturing step, reflective material is deposited over the photo-embossed and cross-linked layer. In a reflective LCD, the reflective material is provided on essentially the entire area of the structured surface. In a transflective LCD, reflective material is only provided on predetermined parts of the surface of the structured layer, leaving openings through which light from a backlight is able to pass.

Preferably, the structure in the irradiated mixture is predominantly developed during a heating step. This allows the layer structure to be better developed, and gives improved control over the photo-embossing process. When the surface relief is developed entirely by irradiation, the light path changes during the formation of the surface relief, because the deforming surface refracts the light in a continuously changing way.

Therefore, it is preferred that during the irradiating step, only a latent image is formed in the mixture layer. For this purpose, a monomer should be chosen that has a relatively low mobility at the irradiation temperature, which is for example room temperature. As a result, the surface relief remains relatively low during irradiation.

The latent image is developed during the subsequent heating step, during which the actual diffusion predominantly takes place. Thus, the properties of the polymer and the concentration of the monomer in the mixture are preferably chosen such that the diffusional mobility of the photo-diffusible monomer is relatively low at room temperature, and relatively high at an elevated temperature. Preferably, also, the glass transition temperature of the polymer is between the temperature at which irradiation is carried out, and the elevated temperature, to further reduce monomer mobility during irradiation.

The elevated temperature now enables the diffusion of the monomer. Preferably, the irradiated mixture is heated to at least 60 degrees Celsius, more preferably about 80 degrees Celsius. For example, the glass transition temperature of the polymer is at least 40 degrees Celsius.

In case the cross-linking step includes thermal cross-linking, the mixture preferably includes a thermal initiator and is preferably heated to about 130 degrees Celsius, so that development of the surface relief and thermal cross-linking especially of the non-irradiated areas occur simultaneously. The inventors have found that in this case the height of the surface relief is not negatively affected. It appears that the balance in diffusion and polymerization kinetics is in favor of diffusion.

By virtue of the heating step, the difference in layer thickness between the irradiated (bright) areas and the masked (dark) areas increases further, and the surface relief is enhanced. Moreover, the desired pattern is first exposed and then developed, so that better control is obtained over the surface structure.

In a preferred embodiment, the mixture comprises an acrylate compound as the photo-diffusible monomer and/or as the polymer. Suitable acrylate compounds include for example pentaerythritoltertaacrylate, trimethylolpropanetriacrylate and phenoxyethylacrylate. Suitable polymers include for example polystyrene, poly(benzil methacrylate) and poly(iso-bornyl methacrylate).

Preferably, the patterned irradiation is effected by using a patterned mask having transmissive and opaque portions corresponding to the pattern to be defined in the mixture layer.

Alternatively, a suitable pattern may be obtained by means of holographic exposure, using two or more irradiation beams interfering on the mixture layer surface.

Preferably, after irradiating in accordance with the first pattern, a further irradiation step is carried out involving irradiating in accordance with a second pattern being different from the first pattern. In this way, more complex surface structures can be formed that diffuse the incident light more efficiently upon reflection and/or are particularly suitable for use in a transflective LCD.

The second pattern is, likewise, preferably obtained by using a second patterned mask, or a subsequent holographic exposure.

Preferably, one of the patterned masks is a greyscale mask. That is, the mask comprises a greyscale pattern having areas where the transmittivity of the mask changes from transmitting to absorbing, in a gradual or step-wise manner. Using a greyscale mask, asymmetric ridges such as saw-tooth structures may easily be formed.

The ridge structures comprise first and second sloping surface portions at an angle with the substrates of the LCD. Incident light is reflected from one of the slopes, so that reflected light is predominantly directed in a different direction as ambient light which is undesirably reflected by the front substrate. Thus, at the viewing angle at which the highest intensity of reflected light is observed, the image is not disturbed by a direct reflection of an ambient light source from the substrate.

This reflector operates similarly as the one disclosed in U.S. Pat. No. 6,285,426. However, the reflector in that patent is generally provided on the outside of the rear substrate, whereas according to the invention the reflector can be manufactured inside the cell of the LCD by means of the photo-embossing process set out in the above. The ridge structure is formed on top of the inner surface of the rear substrate, which inner surface faces the active layer.

Preferably, the first sloping surface portions of the ridge structures are covered with reflective material, and the second sloping surface portions essentially remain free of the reflective material. Thus, a reflector comprising a partial mirror is obtained, which is particularly advantageous for use in a transflective liquid crystal display device. The reflector reflects a relatively high amount of the incident light, but on the other hand the second sloping surface portions define a relatively large opening for passing light from the backlight.

The reflective material may be provided on the photo-embossed structure by means of deposition of vaporized metal particles. For example, vaporized silver (Ag) or aluminum (Al) may be deposited.

In a preferred embodiment, in a transflective LCD device the metal particles are deposited at a grazing angle, such as 20 or 30 degrees with respect to the substrate surface. In this case, parts of the surface remain free of reflective material, because these parts are shielded from the incident metal particles by the raised features of the photo-embossed structure. In this case, an opening for passing light from the backlight is automatically obtained, and no mask is required during the step of depositing the reflective material.

In an alternative embodiment, the reflective material is provided in the form of a solution comprising reflective flakes. These flakes generally are thin, e.g. 100 nm, and have other dimensions in the order of several micrometers, such as 10 μm. For example, aluminum flakes that are dispersed in an organic evaporable solvent can be used. This flake solution can be provided on the photo-embossed structure by means of cost-effective coating techniques, such as blade coating, extrusion coating or spin coating. For a transflective LCD requiring openings in the reflective material, a printing technique may alternatively be used for applying the flake solution. After applying the flake solution, the solvent is evaporated and the flakes remain attached to the photo-embossed surface.

This alternative embodiment is advantageous, as it does not require vacuum conditions for applying the reflective material. Moreover, the flakes are generally distributed with an irregular orientation distribution, leading to an improved diffusion of the incident light on the reflector and consequently a wider viewing cone.

The present invention will now be elucidated with reference to the accompanying drawings. Herein:

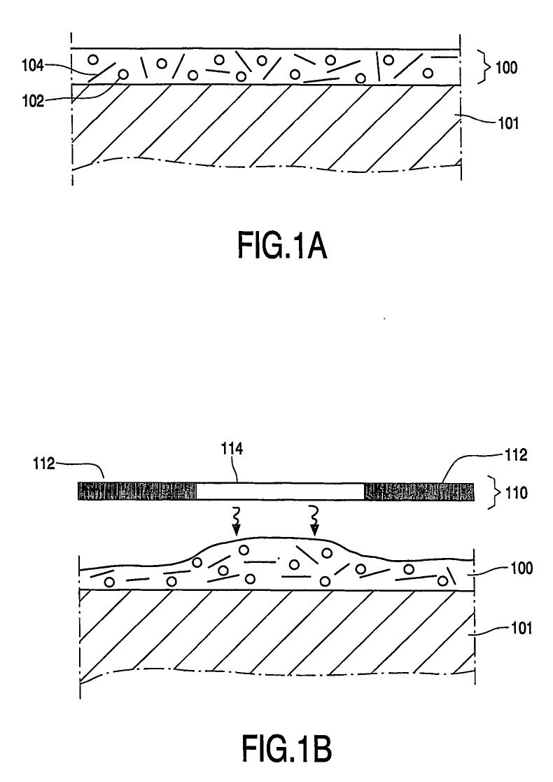

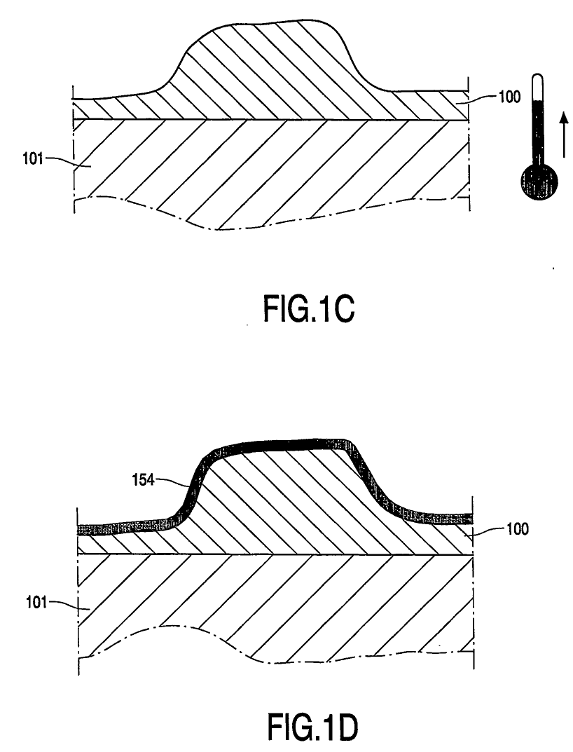

FIGS. 1A-1D shows an embodiment of manufacturing a reflector with a photo-embossed surface relief;

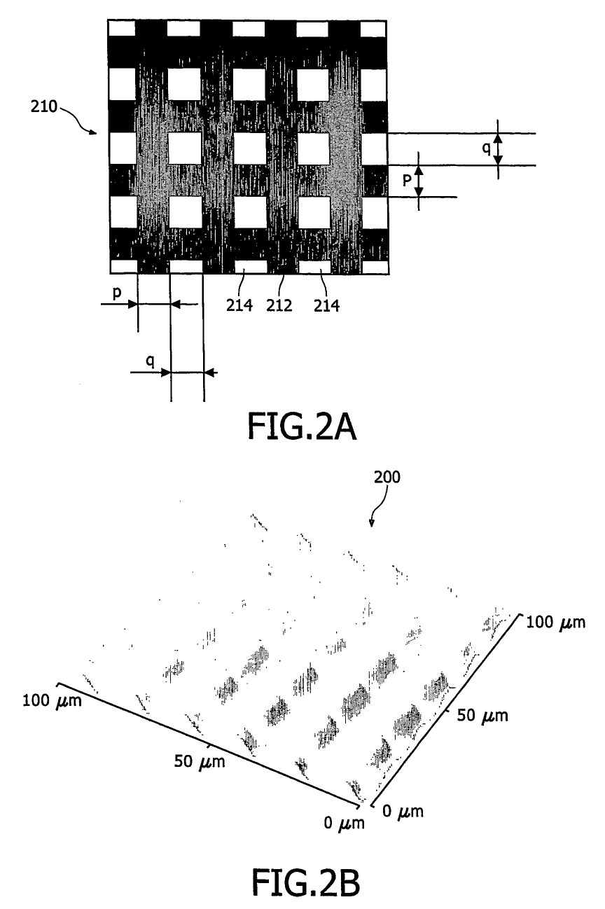

FIGS. 2A-2B shows a surface structure for a diffusive reflector, and a patterned mask suitable for photo-embossing such a surface structure;

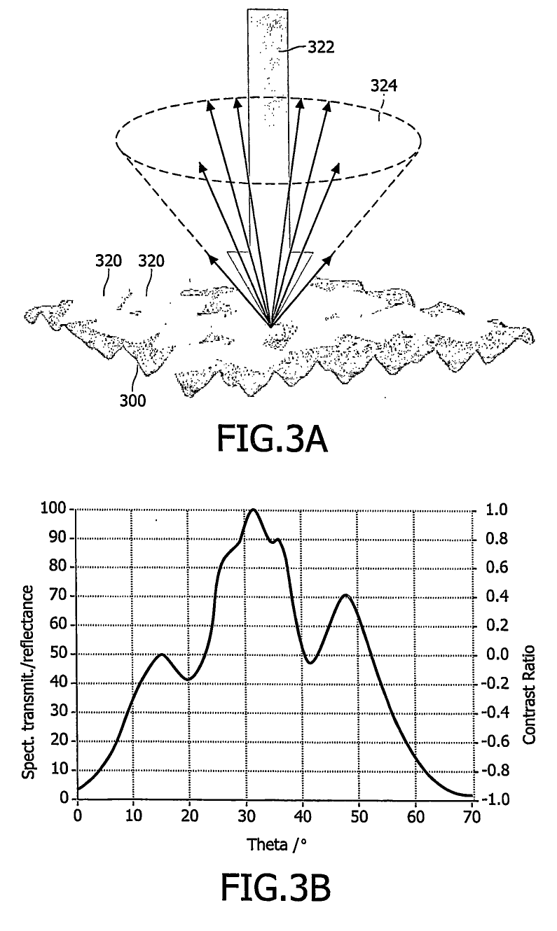

FIGS. 3A-3B is a diffusive reflector having a photo-embossed surface and a mirror comprising reflective flakes;

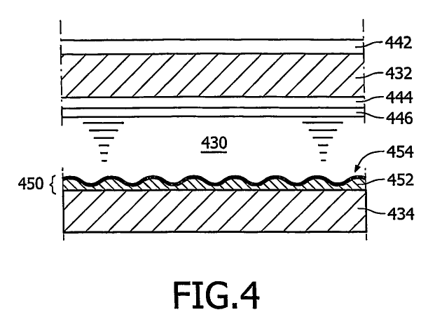

FIG. 4 shows an embodiment of a reflective LCD device with a diffusive reflector;

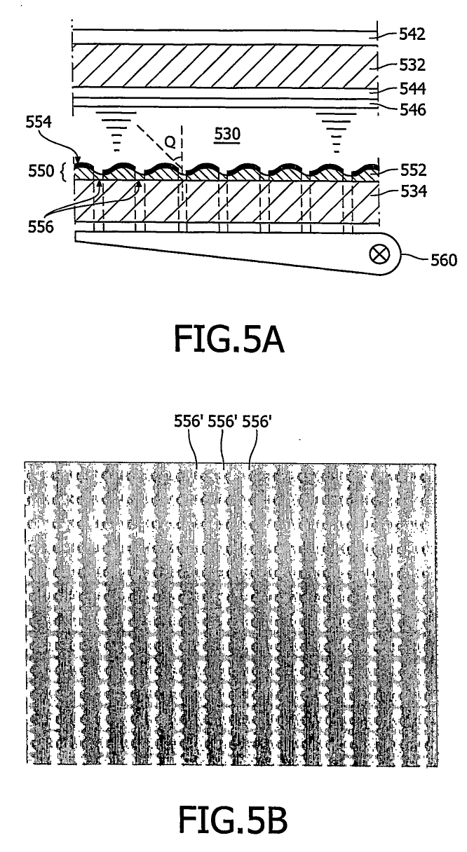

FIGS. 5A-5B shows a first embodiment of a transfiective LCD device with a diffusive reflector;

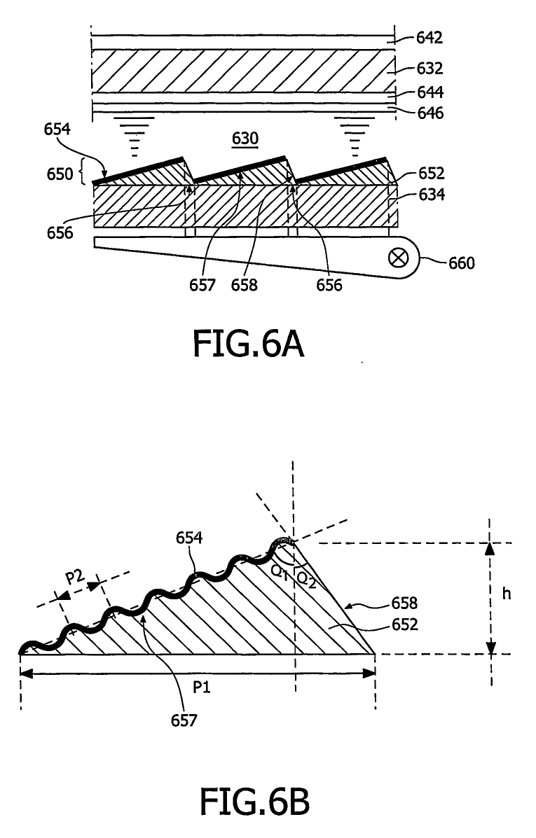

FIGS. 6A-6B shows a second embodiment of a transflective LCD device with a diffusive reflector, and a detail of the latter and

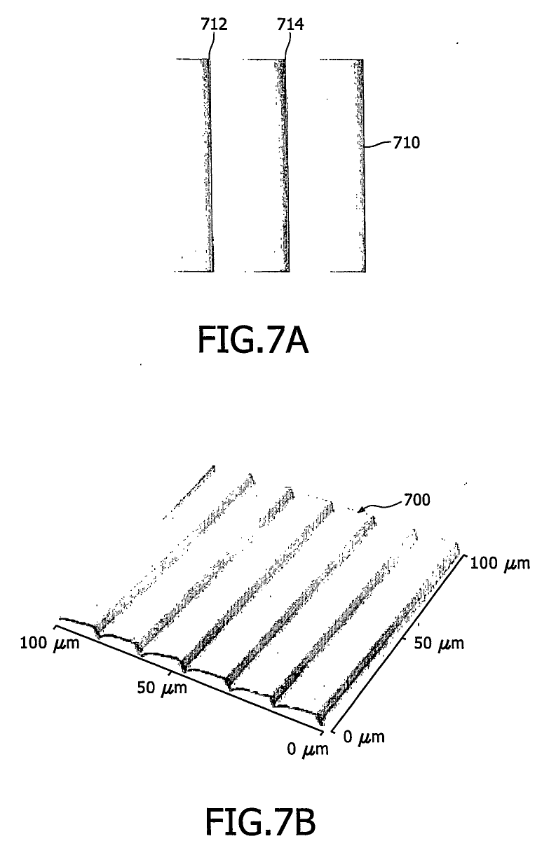

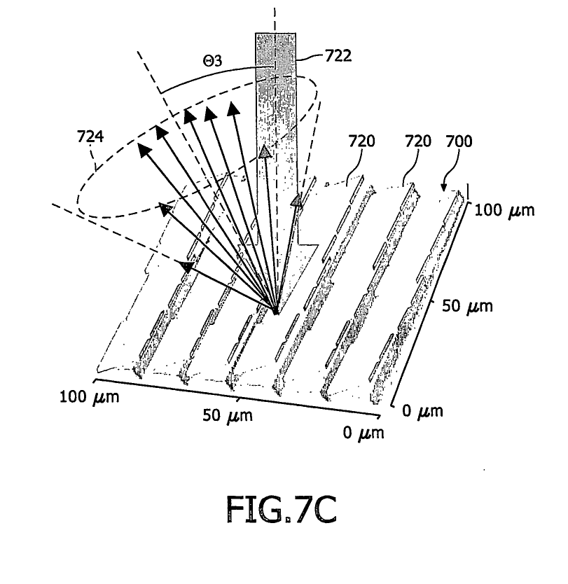

FIGS. 7A-7C illustrate a diffusive reflector with a saw-tooth surface relief, and a patterned mask suitable for photo-embossing such a surface relief.

In the photo-embossing process according to the invention, a surface relief is formed in a layer 100, which is provided on a substrate 101 for example by spin coating or blade coating. The layer is generally provided in the form of a wet coating, it is preferably heated in order to dry it

The layer 100 comprises a mixture of a photo-diffusible monomer 102 and polymer 104. In the initial configuration (FIG. 1A), the monomer and the polymer are both spread out evenly throughout the dried layer.

As an example, the layer may be prepared as follows:
A mixture is prepared of
40% trimethylolpropane triacrylate
20% phenoxyethylacrylate
38% poly(phenoxyethylacrylate) and
2% photoinitiator (Irgacure 651).

This mixture is subsequently dissolved in ethylmethylcellosolve. The wet material obtained is applied as a wet coating on a glass substrate, the thickness of the coating layer being for instance 12 μm. The wet coating may be applied by means of a doctor's blade, or alternatively by means of spin coating at for example 500 rpm or 1000 rpm. Next, the wet coating is dried, for example at 60 degrees Celsius for 30 minutes.

In the example above, the photo-diffusible monomers are trimethylolpropane triacrylate and phenoxyethylacrylate, which are acrylate compounds. Other suitable monomers include pentaerythritoltertraacrylate, trimethylolpropane trimethacrylate, hexanedioldiacrylate, isobornylmethacrylate.

The polymer is poly(phenoxyethylacrylate), alternatively for example polybenzylmethacrylate and polystyrene may be used.

In the next step (FIG. 1B), photo-induced diffusion of the photo-diffusible monomer 102 (in the example above) is obtained by irradiating the layer 100 through a patterned mask 110. The monomer 102 diffuses under the influence of suitable irradiation, preferably collimated ultraviolet (UV) light. The patterned mask 110 comprises dark areas 112 and bright areas 114, the applied irradiation being transmitted substantially only through the bright areas 114. In this case, the monomer 102 diffuses to portions of the layer 100 that are adjacent to bright areas 114 of the mask 110. On the other hand, the polymer 104 is essentially immobile, so that substantially no counter-diffusion of polymer material takes place. As a result, a surface relief is developed in the layer 100. The surface relief is fixed in the layer by a step of cross-linking the polymer material in the layer.

A ‘negative mask’ is needed to form the appropriate surface structure. The negative mask is a mask that is inversed with respect to a ‘positive mask’ needed to form the same surface structure in a conventional lithography process. Portions of the layer that are irradiated in the conventional process are now being masked, and vice versa The irradiation is preferably carried out using a mercury lamp (Ushio; irradiation power 5,3 W cm⁻²) provided with a 365 nm bandpass filter and a grey filter. The irradiation was applied for about 20 minutes.

Alternatively, patterned irradiation is performed y means of holographic exposure of the mixture layer. In this case, two or more irradiation beams are made to interfere on the surface of the layer. This can, for example, be achieved by using a conventional holographic setup.

An irradiation beam, for example a 351 nm wavelength UV beam from an argon laser, is polarized, and the polarized beam is split in two beams of equal intensity, for example by a beam splitter. The two beams are directed towards a portion of the mixture layer to be irradiated, such that they overlap again on the surface of the layer. The resulting irradiation pattern is a sinusoidal interference pattern. The period of the pattern can be adjusted by changing the angle between the two beams.

The surface relief may be enhanced by applying a heating step. It should be noted that this heating step is optional, but preferred in order to obtain a relief that is better developed. Improved control over the photo-embossing process is obtained. During the irradiation, a latent image is formed in the mixture layer, which image is subsequently developed during the heating step. The actual diffusion predominantly takes place after the light exposure through the mask at an elevated temperature. In this way, undesired artefacts in the layer relief are largely prevented. Such artefacts are caused by the deforming surface refracting the light in a continuously changing way.

After the surface structure has being formed the remaining monomers in the unexposed areas need to be polymerized or crosslinked. This can be done by a so-called flood expose where the sample is irradiated without the presence of the mask. But preferably, this polymerization or cross-linking step includes thermal cross-linking, and the layer 100 is heated to 80 degrees for about 10 minutes during which monomer diffusion takes place, and subsequently to 130 degrees for about 5 minutes during which the crosslinking in the unexposed areas takes place. This has the advantage that the surface relief will be well developed, while at the same time the layer is cured and thermally cross-linked during the heating step. No further development or curing of the layer is required. A networked polymer structure is obtained that is provided with the desired surface relief (FIG. 1C). For this purpose preferably a thermal initiator, like an organic peroxide, is added to the mixture that is stable at 80° C. but decomposes rapidly into reactive particles, such as organic free radicals, that initiate the crosslinking reaction at 130° C.

For manufacturing a diffusive reflector for a reflective or transflective LCD, a suitable patterned mask 210 is displayed in FIG. 2A. The mask has square-shaped bright areas 214 with a side length of q. A dark area 212 separates the bright areas 214, which are set at a pitch p from each other. For example, for this mask with p=10 μm and q=10 μm, photo-embossing the layer results in a surface relief 200, a scanning electron microscope (SEM) image of which is shown in FIG. 2B. The raised features in this relief have a height of about 1 μm.

It is noted that the mask shown in FIG. 2A is one of many examples of suitable masks. Alternatively, a mask with a similar pattern may be used wherein p and/or q have different values, or differently patterned masks may be used. The bright areas and/or the dark areas may for example have different shapes, or may be differently arranged with respect to each other.

In a preferred embodiment the mask has a non-symmetric and/or non-periodic surface pattern such that a surface structure is formed that does not suffer from optical disturbances such as interference and moire after application of the reflective layer. The mask for instance may be constructed using a heptagonal-shaped pattern that breaks symmetry and periodicity.

Advantageously, it is possible to form relatively complex surface structures by irradiating the layer through two different patterned masks. This is especially enabled by the fact that the structure of the first irradiation is not formed during or after the exposure but after the second exposure during the heating step simultaneously with the formation of the structure of the second mask exposure. Such complex structures may be advantageous in order to better redistribute the reflected light. As an example, it is possible to superimpose a symmetric surface relief on top of an asymmetric surface relief, or vice versa. For example, a relatively fine superstructure may be superimposed on top of a relatively large base structure.

In this case, for a transflective LCD, one of the patterned masks may define the reflective and transmissive portions of the cell. Thus, by irradiation, a structured layer is formed that establishes different cell thickness (cell gap) for the reflective and transmissive portions. The other patterned mask may again be used to create a superstructure at least for the reflective portions, suitable for a diffusive mirror. For example, the latter mask is that of FIG. 2A.

In a final step (FIG. 1D), a mirror 154 of reflective material is provided on top of the photo-embossed surface relief. For this, a conventional method can be used, wherein a film of vaporized metal particles such as silver or aluminum are deposited on the surface. In a transflective LCD, lithographic processes structure the deposited film in order provide the openings for the transmissive sub-pixels, required for passing light from the backlight The conventional process is however relatively complicated and expensive.

An alternative method of providing a reflective material on the relieved surface will now be discussed with reference to FIG. 3. The method involves the use of a solution of reflective flakes typically having dimensions of several micrometers. The solution is provided on the surface by means of coating techniques such as spin coating or blade coating, or by means of a printing process in case a structured reflective layer is required, such as in a transfiective LCD. After the solution has been applied, the solvent is evaporated and the reflective flakes form a mirror on the surface.

It is noted that the reflective flake coating process set out here does not necessarily have to be carried out on a photo-embossed surface. It is alternatively possible to provide the flakes on a flat surface in order to manufacture a reflector. However, this leads to a noticeably smaller viewing cone. Also, the surface may be structured by means of another method, and then coated with reflective flakes.

A suitable flake solution is for example the commercially available solution ‘Metallure™ W-2002’, which is available ex Eckart. This solution contains reflective aluminum flakes with dimensions between about 3 and about 45 μm, typically about 12 μm. The thickness of the flakes is between 10 and 200 nm. The organic solvent used is a blend of ethanol, acetone and 2-propanol in a weight distribution of 18:1:1. The amount of aluminum flakes in the solvent is typically between 2 and 40 weight percent. To ensure that the solution is distributed well over the structured surface, a low concentration of a surfactant is added.

A photo-embossed surface relief 300, provided with a mirror of reflective flakes 320, is illustrated in FIG. 3A. Light 322 incident onto the surface is reflected and redistributed into a viewing cone 324. The angular distribution of the reflected light is widened, as the surface acts as a diffusive reflector due to the photo-embossed surface structure.

The angular distribution of the reflected light is illustrated in the graph of FIG. 3B. A sample of a diffusive reflector as shown in FIG. 3A was prepared by photo-embossing a surface relief and coating this surface relief with an aluminum flake solution.

The sample was illuminated using collimated light, at a grazing angle of −30 degrees with respect to the surface normal, and the intensity of reflected light was measured through an angular distribution from 0 degrees (normal to surface) to 90 degrees (parallel to surface). The maximum intensity occurs for a reflection angle that coincides with the angle of incidence, thus approximately 30 degrees. However, it can be seen that the reflected light has a relatively wide angular distribution. Between 15 and 55 degrees, the intensity of the reflected light is at least 50% of the maximum intensity. This wide viewing cone allows a viewer to use the display through a relatively large range of viewing angles.

An embodiment of a reflective LCD according to the invention is shown in FIG. 4.

The LCD comprises a cell 430 sandwiched between a front substrate 432 on the viewer side, and a rear substrate 434. The cell 430 includes an active layer of a liquid crystalline (LC) material.

The substrates 432, 434 are glass substrate and comprise driving means for addressing the picture elements (pixels) of the LCD. Said driving means generally comprise a matrix structure of row electrodes and column electrodes (not shown). A single pixel corresponds to an intersection of a row electrode and a column electrode. By applying a voltage difference over a pixel, light modulation by the active layer changes.

For example, in a cell comprising an active layer of twisted nematic (TN) or a super twisted (SIN) liquid crystalline material, applying a voltage difference generally causes an electric field over the pixel, directed perpendicular to the substrates 432, 434. The LC material re-arranges itself in the direction of the electric field. At a certain voltage difference, the long axis of the molecule is substantially aligned with the field lines of the applied electric field.

As a result, a viewer will perceive a different pixel greyscale value for different applied fields, because the effective optical birefringence of the active layer varies with the orientation of the LC molecules.

In an LCD device of the active matrix type, the driving means further comprise a thin film transistor (TFT) for each pixel.

The front substrate 432 is provided with a linear polarizer 442. The cell 430 further comprises, on the inner surface of the front substrate 432 facing the active layer, a retarder 444 and a color filter 446. The retarder 444 is for example a quarter wave retarder that forms a circular polarizer in conjunction with the linear polarizer 442. The color filter 446 is one of an array of color filters associated with different primary colors, for separating white light into light of the different primary colors. The different color filters define sub-pixels within a pixel of the color LCD. Usually, the color filter array includes green, red and blue color filters, so that each color pixel of the LCD consists of three sub-pixels. In the drawings, only one sub-pixel is shown with a single color filter 446.

The operation of the reflective LCD relies on reflection of ambient light incident onto an in-cell diffusive reflector 450. Thus ambient light falls onto the LCD, is circularly polarized by the polarizer 442 and retarder 444, passes the active layer, is reflected back, and passes the active layer, the retarder 444 and the polarizer 442 for a second time. The amount of light that exits from the reflective LCD is dependent on modulation of the light by the active layer, which modulation is again determined by the applied electric field over the active layer.

According to the invention, the diffusive reflector 450 is formed by means of a photo-embossing process. Thus, it comprises a layer 452 with a photo-embossed surface relief, covered by a mirror 454 of reflective material, such as aluminum. If the height of the surface relief is relatively large with respect to the cell gap (thickness of the active layer), it may need to be covered with an extra planarization layer (not shown), as too large cell gap variations lead to deterioration of the optical characteristics of the LCD.

A first embodiment of a transflective LCD, as shown in FIG. 5A, uses a similar design at the side of the front substrate 532. Thus, the front substrate 532 is provided with a linear polarizer 542. The cell 530 further comprises, on the inner surface of the front substrate 532 facing the active layer, a retarder 544 and a color filter 546. The retarder 544 is for example a quarter wave retarder that forms a circular polarizer in conjunction with the linear polarizer 542.

However, at the side of the rear substrate 534, the diffusive reflector 550 now comprises a partial mirror 554 on the photo-embossed layer 552, with openings 556 for passing light from the backlight 560. A rear linear polarizer 562 is provided on the rear substrate 534 for linearly polarizing the light from the backlight 560, before the light enters the cell 530.

The partial mirror 554 may be formed by a conventional vaporized metal deposition process, whereby preferably the particle stream is directed towards the surface 552 at a grazing angle indicated in the figure by θ.

Thus, a preferred method to apply the reflective layer is by evaporating or sputtering the metal coating at grazing angle. Thereto the line between source of the metal material that is to be transferred and the normal of the average of the surface plane makes a large angle, i.e. between 60° and 88°, but preferably between 70° and 80°. During the formation of the film parts of the surface relief will be shielded from the metal particle source and will not be coated with the metallic mirror. Because of this a directionality is obtained that, when applied in the right position in the display with respect to the most logical position of the watcher of the display, provides a maximization in the trade-off between reflection of ambient light and transmittivity of the backlight.

In this way, a partial mirror 554 can be formed that does not need to be structured using lithography. The raised features of the relief in layer 552 shield parts of the surface from incident metal particles, so that these parts substantially remain free of reflective material. This results in the formation of the partial mirror 554, with openings 556 at the location of said parts of the surface.

FIG. 5B shows a sample of such a partial mirror made during an experiment. A photo-embossed surface structure 500 was formed similar to the one shown in FIG. 2B, and reflective material was provided thereon by means of metal vapor deposition at a grazing angle. After curing the reflective layer, the sample was backlit and the image of FIG. 5B was made. The relief on the surface shields portions of the surface from the metal particle stream, so as to define openings 556′ on the surface. In the figure, light from the backlight can be seen to pass through these openings 556′.

A second embodiment of a transflective LCD is shown in FIG. 6A. Again, this embodiment has a similar construction at the side of the front substrate 632. Thus, the front substrate 632 is provided with a linear polarizer 642. The cell 630 further comprises, on the inner surface of the front substrate 632 facing the active layer, a retarder 644 and a color filter 646. The retarder 644 is for example a quarter wave retarder that forms a circular polarizer in conjunction with the linear polarizer 642.

The diffusive reflector 650 has a photo-embossed layer 652 structured in a saw-tooth relief, on top of which a finer superstructure has been formed. The saw-tooth pattern is photo-embossed using a patterned grey scale mask such as the one displayed in FIG. 7A, the mask pitch being for example 10 or 20 μm. The superstructure is photo-embossed on top of the saw-tooth pattern, for example using a second patterned mask such as the one described earlier with reference to FIG. 2A.

A detail of the saw-tooth relief is shown in FIG. 6B. The saw-tooth relief comprises two sloping planes, namely a relatively long slope 657 and a relatively short slope 658. The saw-tooth structure has a pitch p1 of for example 10 or 20 μm. The diffusive superstructure having a pitch p2 of for example 0,5 or 1 μm is provided on the long slope 657.

The reflector 650 is provided with reflective material on its long slope 657, and remains substantially free of reflective material on its short slope 658. In this case, the planes of the short slopes 658 form the openings 656 for passing light from the backlight. A partial mirror 654 is formed, where light reflection occurs essentially only at the surfaces of the long slopes 657 of the saw-tooth structure.

The plane of a long slope 657 is at an angle θ1 with the surface normal. Because of this, the reflection angle with maximum intensity of the reflected light (see FIG. 3A) is displaced with respect to the surface and the surface normal, over an angle of (90-θ1) degrees. This is advantageous, as a maximum intensity reflection is no longer disturbed by glare, i.e. direct reflection of ambient light sources on the display surfaces such as the front plane and the substrate surfaces. Preferably, θ1 is between 60 and 85 degrees, most preferably about 80 degrees.

At the same time, the plane of a short slope 658 is at angle θ2 with the surface normal. This angle should be larger than zero in order to create an opening 656 through which light from the backlight can enter the display. However, θ2 should not be too large as this reduces the effective reflective surface area of the reflector 650. Preferably, θ2 is between 15 and 45 degrees, most preferably about 30 degrees. In combination with a θ1 value of about 80 degrees, this leads to a surface relief height h of about 1,5 μm, which the inventors have found to be easily achievable using the photo-embossing manufacturing process according to the invention.

To provide reflective material on essentially only the long slopes 657, the reflective material is for example provided by evaporation at a grazing angle, in this case an angle with the surface normal larger than θ2. The short slopes 658 are now effectively shielded from the metallic particle stream.

Preferably, a reflective flake solution is used for providing the reflective material. As the solution has to be provided in a patterned manner, leaving reflective flakes on essentially only the long slopes 657, a printing technique is preferred for providing the flake solution.

In another coating process the aluminium flakes dispersed in solution are applied by a doctor blade coating knife. Thereto a 5 μM wet film of the aluminium dispersion is applied on the structured layer. After forming the film a simultaneous process of evaporation of the solvent and sedimentation of the particles takes place. When the evaporation is slow in relation to the sedimentation the aluminum flakes, because of their anisotropic shape, preferably land on the long slopes 657 of the layer, and not on the part that make a large angle with the substrate, i.e. the short slopes 658 which are nearly perpendicularly oriented with respect to the surface. In this way automatically a periodic opening is left for light transmission.

The angular distribution of reflection intensity is similar to that shown in FIG. 3B, however shifted through an angle of (90-θ1) degrees. Thus, if a saw-tooth structured sample having θ1=80 degrees is illuminated using collimated light incident at −30 degrees, the angle of maximum reflection intensity is about 20 degrees.

The photo-embossed layer 652 is provided with a saw-tooth pattern by means of irradiating the layer through a patterned greyscale mask 710 such as the one shown in FIG. 7A. The mask transmittance changes gradually, from transmitting at bright areas 712 to absorbing at dark areas 714. Such a mask, having a mask pitch of 16 μm, was used in an experiment. After irradiating and developing the layer, a SEM image of the resulting photo-embossed sawtooth surface 700 was made. This image is shown in FIG. 7B.

FIG. 7C shows this surface 700 provided with reflective flakes 720. Light 722 incident onto the surface 700 is reflected and redistributed into a viewing cone 724. The central axis of the viewing cone 724 is at an angle θ3=(90-θ1) degrees with the direction of the incident light, which is in this case perpendicular to the surface normal.

In summary, the invention relates to a method for manufacturing a diffusive reflector for a reflective or transflective Liquid Crystal Display. The reflector comprises a surface that is structured by means of a photo-embossing process. Herein, a layer of a mixture is provided including a photo-diffusible monomer, which may be transported through the layer under the influence of selectively applied irradiation. A layer relief is thus formed, which is preferably developed further at an elevated temperature. The layer is fixed and stabilized by means of a cross-linking step, preferably including thermally induced and/or photo-induced polymerization. In a final step, the polymer relieved surface thus formed is provided with a reflective material.

1. A method of manufacturing a reflector for a reflective or transflective liquid crystal display device, comprising the steps of
providing a layer comprising a mixture including a photo-diffusible monomer;
selectively irradiating said mixture in accordance with a first pattern for developing a photo-embossed structure in said layer;
cross-linking said mixture and
providing at least selected surface portions of the photo-embossed layer with a reflective material.

2. A method as claimed in claim 1, wherein the mixture further includes a polymer.

3. A method as claimed in claim 1, wherein the photo-diffusional monomer is a monomer that contains at least one polymerizable group forming a cross-linked polymer network after polymerization.

4. A method as claimed in claim 1, wherein the mixture further comprises a thermal initiator for thermally cross-linking photo-diffusible monomer remaining at least in a non-irradiated area of the layer after the irradiating step.

5. A method as claimed in claim 1, further comprising the step of heating the mixture after the irradiating step, for enhancing the photo-embossed structure at an elevated temperature.

6. A method as claimed in claim 5, wherein the elevated temperature is at least 60 degrees Celsius.

7. A method as claimed in claim 4, wherein the elevated temperature is about 130 degrees Celsius.

8. A method as claimed in claim 1, wherein the photo-diffusible monomer and/or the polymer is an acrylate compound.

9. A method as claimed in claim 1, wherein the mixture is irradiated through a first patterned mask.

10. A method as claimed in claim 1, wherein the mixture is irradiated by means of holographic exposure.

11. A method as claimed in claim 1, wherein the method further comprises a step of selectively irradiating the layer in accordance with a second pattern.

12. A method as claimed in claim 11, wherein the mixture is irradiated through a second patterned mask after being irradiated through the first patterned mask.

13. A method as claimed in claim 9, wherein the first patterned mask or the second patterned mask comprises a grey scale pattern.

14. A method as claimed in claim 9, wherein the first patterned mask or the second patterned mask comprises a non-periodic and/or non-symmetric pattern.

15. A method as claimed in claim 1, wherein the step of providing the reflective material further comprises depositing vaporized metal particles on the selected surface portions of the layer.

16. A method as claimed in claim 15, wherein the metal particles are deposited at a grazing angle with respect to an outer surface of the substrate.

17. A method as claimed in claim 1, wherein the step of providing the reflective material further comprises
providing a solution including reflective flakes and
evaporating said solution, thereby leaving said reflective flakes randomly dispersed on the selected surface portions of the cross-linked layer.

18. A reflective or transflective LCD device, comprising a cell between a front substrate and a rear substrate, said cell including an active layer of a liquid crystalline material, and a reflector for reflecting ambient light modulated by said active layer towards a viewer, wherein said reflector has a polymer surface being provided with a surface relief by means of a photo-embossing process, and at least part of said polymer surface is provided with a reflective material.

19. A reflective or transflective LCD device as claimed in claim 18, wherein the surface relief comprises a ridge structure including first and second sloping surface portions.

20. A transflective LCD device as claimed in claim 19, wherein the reflective material is provided on said first sloping surface portions, and the second sloping surface portions essentially define an opening for passing light from a backlight.

21. A transfiective LCD device as claimed in claim 18, wherein the surface relief substantially defines a difference in cell gap between reflective and transmissive portions of the cell, the reflective material substantially being provided on a part of the surface corresponding to said reflective portions.
